(19) United States
(12) Patent Application Publication
(10) Pub. No.: US 2002/0185214 A1
(43) Pub. Date: Dec. 12, 2002

(54) Manufacturing apparatus and method for high tensile strength bag material

(76) Inventor: Wei-Ling Hsu, Taipei (TW)

Correspondence Address: BACON & THOMAS, PLLC, 625 SLATERS LANE, FOURTH FLOOR, ALEXANDRIA, VA, 22314

(21) Appl. No.: 09/876,126

(22) Filed: Jun. 8, 2001

(51) Int. Cl. B29B 7/00

(52) U.S. Cl. 156/243; 156/324; 156/555

(57) ABSTRACT

A manufacturing apparatus and method for making high tensile strength bag material, the apparatus consists of a first feeding mechanism, a second feeding mechanism located on the deliver process of the first feeding mechanism, a set of opposing roller calender mechanism located behind the second feeding mechanism and a receiving mechanism behind the roller calendar mechanism. A roll of mesh belt is mounted on the first feeding mechanism and delivered therefrom. During transportation of the mesh belt, the second feeding mechanism delivers plastic films to cover the mesh belt. Then the mesh belt and plastic films are formed under heat and between ramming rollers in the roller calendar mechanism, and then are cooled in a cooling apparatus to make the mesh belt and plastic films bonding together. Finally, the bonded mesh belt and plastic films are wound by the receiving mechanism to become a high tensile strength bag material.

### BACKGROUND OF THE INVENTION

The present invention relates to a manufacturing apparatus and method for high tensile strength bag material and particularly to increase bag strength and toughness for preventing deformation and fracture.

The common plastic bags for holding goods now being widely used on the market usually are made from Poly Urenthane (PU) or Polyester (PE). The bags generally have an integrally formed handle to facilitate users taking of the bags.

The plastic bags set forth above generally are formed by PU (or PE) films. They do not have sufficient strength and toughness. The weight and shapes of the holding goods could easily stretch and expand the bags, and will result in deformation of the bags. The thin plastic films also are prone to fracture when the holding goods have sharp angles or polygon shapes and make the bags become useless. As the handle is integrally formed with the bag, it tends to stretch and deform under the heavy load because of its weak strength and toughness. The bags thus made are not durable and cannot be used repetitively. It is a waste of resources and also causes serious environmental problems.

### SUMMARY OF THE INVENTION

The primary object of the present invention is to resolve the foregoing disadvantages. The present invention aims at providing a manufacturing apparatus and method for making a high tensile strength bag material, and particularly a bag material that can increase the strength and toughness of the bags, and may prevent deformation and fracture of the bags.

Another object of the present invention is allow the bags reusable repetitively.

To attain the foregoing objects, the present invention consists of a first feeding mechanism, a second feeding mechanism located on the deliver process of the first feeding mechanism, a roller calender mechanism behind the second feeding mechanism and a receiving mechanism behind the roller calender mechanism. The first feeding mechanism is used to deliver a mesh belt winding in a roll. The second feeding mechanism is to deliver plastic films during the transportation of the mesh belt. The roller calender mechanism is to apply heat and rolling pressure for forming the mesh belt and plastics films together, and a cooling apparatus is provided to cool the mesh belt and plastic films for forming a strong bonding. The receiving mechanism is to collect and wind the bonded material.

The foregoing, as well as additional objects, features and advantages of the invention will be more readily apparent from the following detailed description, which proceeds with reference to the accompanying drawings.

### BRIEF DESCRIPTION OF THE DRAWINGS

FIG. 1 is a schematic view of the manufacturing apparatus of the present invention.

FIG. 2 is a schematic view of an embodiment of the manufacturing apparatus of the present invention.

FIG. 3 is the manufacturing process flow of the present invention.

FIG. 4 is a schematic sectional view of the bonded mesh belt and plastic films.

### DESCRIPTION OF THE PREFERRED EMBODIMENT

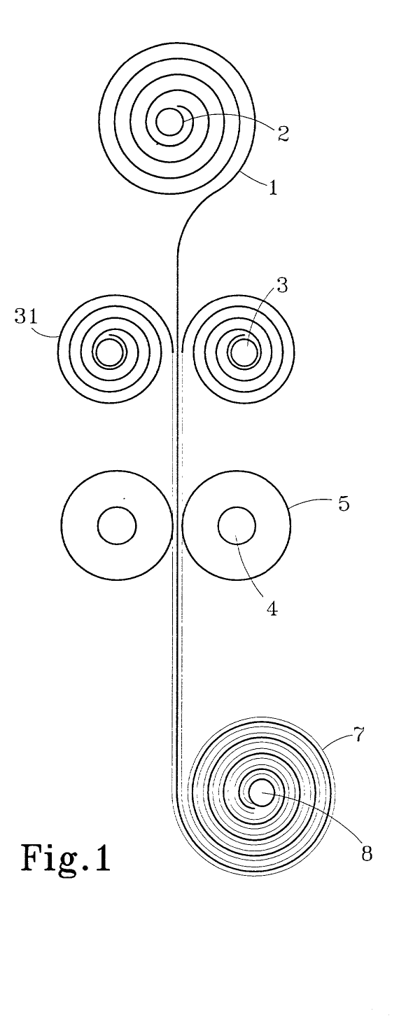

Referring to FIG. 1, the manufacturing apparatus according to the present invention consists of a first feeding mechanism 2, a second feeding mechanism 3 located on the deliver process of the first feeding mechanism 2, an opposing roller calender mechanism 5 located behind the second feeding mechanism 3 and a receiving mechanism 8 located behind the roller calender mechanism 5. The roller calender mechanism 5 has a gap which is adjustable according to the actual requirements.

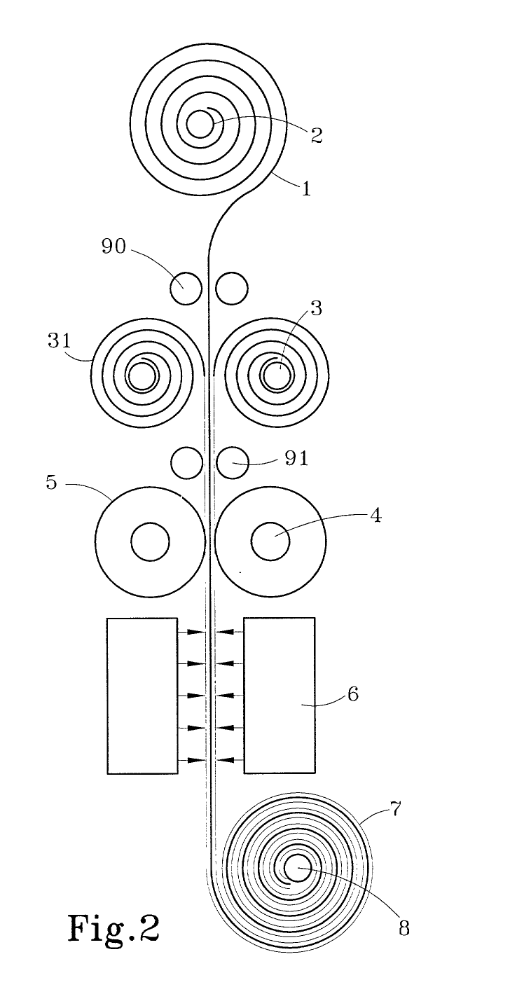

Referring to FIG. 2, when the apparatus of the invention is set up for producing the high tensile strength bag material, a set of opposing first leveling rollers 90 may be added between the first feeding mechanism 2 and second feeding mechanism 3, and a set of opposing second leveling rollers 91 may be added between the second feeding mechanism 3 and roller calender mechanism 5. In addition, a cooling apparatus 6 may be added between the roller calender mechanism 5 and receiving mechanism 8.

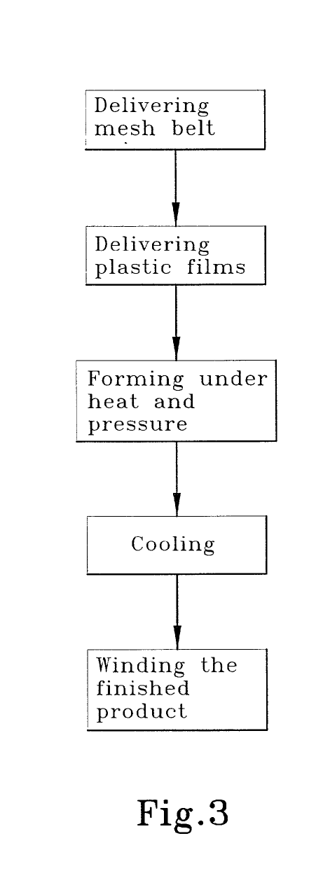

Referring to FIGS. 2 and 3, the method of using the apparatus of the present invention to produce the high tensile strength bag material is as follows:

Mount a roll of mesh belt 1 on the first feeding mechanism 2 and deliver the mesh belt 1 outward, the mesh belt 1 is transported through the opposing first leveling rollers 90 for leveling to prevent the mesh belt 1 from forming creases or unevenness.

During the transportation of the mesh belt 1, the second feeding mechanism 3 delivers plastic films 31 to cover the mesh belt 1. Then coupled the mesh belt 1 and plastic films 31 are transported to the opposing second leveling rollers 91 for another leveling process to prevent the mesh belt 1 and plastic films 31 from forming creases or unevenness. The plastic films 31 may be made from PU (or PE).

The mesh belt 1 and plastic films 31 then will be transported to a heater 4 located in the roller calender mechanism 5 to be formed under heat and between ramming rollers.

After forming in the roller calender mechanism 5, the mesh belt 1 and plastic films 31 are transported to the cooler 6 for cooling and to make the plastic films 31 completely covering and bonding to the surface of the mesh belt 1.

Finally, the bonded mesh belt 1 and plastic films 31 are taken up and wound by the receiving mechanism 8. The bags formed by the material thus made has a greater tensile strength and toughness, and may prevent deformation and fracture when in use.

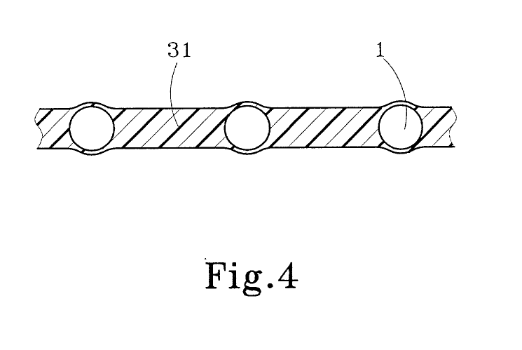

Referring to FIG. 4, the mesh belt 1 and plastic films 31 after bonding and forming under heat and pressure in the heater 4 and roller calender mechanism 5, the plastic films 31 will bond to the mesh belt 1 such that the plastic films 31 will have the mesh belt 1 embedded and interwoven thereon. The bags formed by the material thus made has a greater tensile strength and toughness, and may prevent deformation and fracture when in use.

While the preferred embodiment of the invention has been set forth for the purpose of disclosure, modifications of the disclosed embodiments of the invention as well as other embodiment thereof may occur to those skilled in the art. Accordingly, the appended claims are intended to cover all embodiments which do not depart from the spirit and scope of the invention.

What is claimed is:

1. A manufacturing apparatus for making high tensile strength bag material, comprising:
a first feeding mechanism;
a second feeding mechanism located on a deliver process of the first feeding mechanism;
an opposing roller calender mechanism located behind the second feeding mechanism including a heater; and
a receiving mechanism located behind the roller calender mechanism.

2. The manufacturing apparatus and method of claim 1 further having a set of opposing first leveling rollers located between the first feeding mechanism and the second feeding mechanism for leveling use.

3. The manufacturing apparatus and method of claim 1 further having a set of opposing second leveling rollers located between the second feeding mechanism and the roller calender mechanism for leveling use.

4. The manufacturing apparatus and method of claim 1 further having a cooling apparatus located between the roller calender mechanism and the receiving mechanism.

5. A manufacturing method for making high tensile strength bag material, comprising the steps of:
a. mounting a roll of mesh belt on a first feeding mechanism and delivering the mesh belt outward;
b. delivering plastics films from a second feeding mechanism during delivery of the mesh belt;
c. forming the delivered mesh belt and the plastic films under heat and pressure in a roller calender mechanism;
d. cooling the formed mesh belt and the plastic films in a cooling apparatus to bond the mesh belt and the plastic films; and
e. winding the bonded mesh belt and the plastic films through a receiving mechanism.

6. The manufacturing and method of claim 5, wherein plastic films are selectively made from PU or PE.
